(19) United States
(12) Patent Application Publication
(10) Pub. No.: US 2021/0300807 A1
(43) Pub. Date: Sep. 30, 2021

(54) APPARATUS AND METHODS FOR FABRICATING GLASS RIBBON

(71) Applicant: CORNING INCORPORATED, CORNING, NY (US)

(72) Inventors: Alexey Sergeyevich Amosov, Avon (FR); Ilya Svyatogorov, Saint-Petersburg (RU); William Anthony Whedon, Corning, NY (US)

(21) Appl. No.: 17/266,251

(22) PCT Filed: Aug. 6, 2019
(86) PCT No.: PCT/US2019/045268

§ 371 Date: Feb. 5, 2021

Related U.S. Application Data
(60) Provisional application No. 62/717,170, filed on Aug. 10, 2018.

(51) Int. Cl. C03B 5/42; C03B 17/06; C03B 18/16

(52) U.S. Cl. CPC C03B 5/42; C03B 18/16; C03B 17/064

(57) ABSTRACT

Apparatus can comprise a containment device including a surface defining a region extending in a flow direction of the containment device. A support member positioned to support a weight of the containment device can comprise a support material with a creep rate from 1×10⁻¹² l/s to 1×10⁻¹⁴ l/s under a pressure of from 1 MPa to 5 MPa at a temperature of 1400° C. In some embodiments, the support material can comprise a ceramic material. In some embodiments, the support material can comprise silicon carbide. In some embodiments, a platinum wall can be spaced from physically contacting any portion of the support member. In some embodiments, methods can comprise flowing the molten material within the region in the flow direction while supporting a weight of the containment device with the support member.

### CROSS-REFERENCE TO RELATED APPLICATION

This application claims the benefit of priority under 35 U.S.C. § 119 of U.S. Provisional Application Ser. No. 62/717,170 filed on Aug. 10, 2018, the content of which is relied upon and incorporated herein by reference in its entirety.

### BACKGROUND

It is known to process molten material into a glass ribbon with a forming apparatus. Conventional forming apparatus are known to operate to down draw a quantity of molten material from the forming apparatus as the glass ribbon.

### SUMMARY

The following presents a simplified summary of the disclosure to provide a basic understanding of some exemplary embodiments described in the detailed description.

The present disclosure relates generally to apparatus and methods for fabricating a glass ribbon and, more particularly, to containment device for containing molten material and a support member to support a weight of containment device and methods for containing molten material with the containment device while a weight of the containment device and molten material within the containment device are supported by the support member.

In accordance with some embodiments, an apparatus can comprise a conduit comprising a peripheral wall defining a region extending in a flow direction of the conduit. A first portion of the peripheral wall of the conduit can comprise a slot extending through an outer peripheral surface of the peripheral wall. The slot can be in communication with the region. The apparatus can further include a support member comprising a support surface defining an area receiving a second portion of the peripheral wall. The support member can comprise a support material comprising a creep rate from 1×10⁻¹² l/s to 1×10⁻¹⁴ l/s under a pressure of from 1 MPa to 5 MPa at a temperature of 1400° C. The apparatus can still further include a forming wedge positioned downstream from the slot of the conduit. The forming wedge can comprise a first wedge surface and a second wedge surface that conv [symbol] downstream direction to form a root of the forming wedge.

In one embodiment, the support material comprises a ceramic material.

In another embodiment, the ceramic material can comprise silicon carbide.

In accordance with other embodiments, an apparatus can comprise a conduit comprising a peripheral wall defining a region extending in a flow direction of the conduit. A first portion of the peripheral wall of the conduit can comprise a slot extending through an outer peripheral surface of the peripheral wall. The slot can be in communication with the region. The apparatus can further include a silicon carbide support member comprising a support surface defining an area receiving a second portion of the peripheral wall. The apparatus can still further include a forming wedge positioned downstream from the slot of the conduit. The forming wedge can comprise a first wedge surface and a second wedge surface that converge in a downstream direction to form a root of the forming wedge.

In one embodiment, the support surface can surround from about 25% to about 60% of the outer peripheral surface of the peripheral wall.

In another embodiment, a depth of the area receiving the second portion of the peripheral wall varies along a length of the slot.

In another embodiment, the depth of the area receiving the second portion of the peripheral wall can be greatest at a location of less than about 33% of the length of the slot measured in the flow direction of the conduit.

In another embodiment, the conduit can comprise a first conduit connected in series with a second conduit at a joint. The depth of the area receiving the second portion of the peripheral wall can be greater at a lateral location of the joint than at an intermediate lateral location of the first conduit and an intermediate lateral location of the second conduit.

In another embodiment, the first portion of the peripheral wall can be opposite the second portion of the peripheral wall.

In another embodiment, the width of the slot can increase in the flow direction of the conduit.

In another embodiment, a cross-sectional area of the reg [symbol] perpendicular to the flow direction of the conduit can decrease in the flow direction of the conduit.

In another embodiment, the outer peripheral surface of the peripheral wall can comprise a circular shape along a cross-section taken perpendicular to the flow direction of the conduit.

In another embodiment, a thickness of the peripheral wall of the conduit can be from about 3 mm to about 7 mm.

In another embodiment, the peripheral wall of the conduit can comprise platinum.

In another embodiment, the apparatus can further comprise a first sidewall defining the first wedge surface and a second sidewall defining the second wedge surface.

In another embodiment, the first sidewall can comprise platinum and the second sidewall can comprise platinum.

In another embodiment, the support member can be positioned between the first sidewall and the second sidewall.

In another embodiment, the first sidewall and the second sidewall do not physically contact any portion of the support member.

In another embodiment, an upstream end of an upstream portion of the first sidewall can be attached to the peripheral wall of the conduit at a first interface. Furthermore, an upstream end of an upstream portion of the second sidewall can be attached to the peripheral wall of the conduit at a second interface.

In another embodiment, the first interface and the second interface can each be located downstream from the slot of the conduit.

In another embodiment, the upstream portion of the first sidewall and the upstream portion of the second sidewall can flare away from one another in the downstream direction.

In another embodiment, a method of fabricating a glass ribbon from a quantity of molten material with the apparatus can comprise flowing the molten material within the region in the flow direction of the conduit. The method can further include flowing molten material through the slot from the region of the conduit as a first stream of molten material and a second stream of molten material. The method can further include flowing the first stream of molten material [symbol] wedge surface along the downstream direction and the second stream of molten material on the second wedge surface along the downstream direction. The method can further include fusion drawing the first stream of molten material and the second stream of molten material from the root of the forming wedge as a glass ribbon.

In accordance with other embodiments, an apparatus can comprise a support member comprising a support trough, a first support weir, and a second support weir. The support trough can be laterally positioned between the first support weir and the second support weir. The support member can comprise a support material comprising a creep rate from 1×10⁻¹² l/s to 1×10⁻¹⁴ l/s under a pressure of from 1 MPa to 5 MPa at a temperature of 1400° C. The apparatus can further comprise an upper wall at least partially defining a molten material trough positioned within the support trough and supported by the support trough. In some embodiments, the upper wall does not physically contact any portion of the support member. The apparatus can further comprise a first sidewall comprising an upper portion attached to a first side of the upper wall. In some embodiments, the first sidewall does not physically contact any portion of the support member. The apparatus can further comprise a second sidewall comprising an upper portion attached to a second side of the upper wall. In some embodiments, the second sidewall does not physically contact any portion of the support member. The apparatus can further comprise a forming wedge comprising a first wedge surface defined by a lower portion of the first sidewall and a second wedge surface defined by a lower portion of the second sidewall. The first wedge surface and the second wedge surface can converge in a downstream direction to form a root of the forming wedge.

In one embodiment, the support material can comprise a ceramic material.

In another embodiment, the ceramic material can comprise silicon carbide.

In accordance with other embodiments, an apparatus can comprise a silicon carbide support member comprising a support trough, a first support weir, and a second support weir. The support trough can be laterally positioned between the first support weir and the second support weir. The apparatus can further comprise an upper wall at least partially defining a molten material trough positioned within the support trough and supported by the support trough. In some embodiments [symbol] wall does not physically contact any portion of the silicon carbide support member. The apparatus can further include a first sidewall comprising an upper portion attached to a first side of the upper wall. In some embodiments, the first sidewall does not physically contact any portion of the support member. The apparatus can further include a second sidewall comprising an upper portion attached to a second side of the upper wall. In some embodiments, the second sidewall does not physically contact any portion of the support member. The apparatus can further comprise a forming wedge comprising a first wedge surface defined by a lower portion of the first sidewall and a second wedge surface defined by a lower portion of the second sidewall. The first wedge surface and the second wedge surface can converge in a downstream direction to form a root of the forming wedge.

In one embodiment, an intermediate material prevents the upper wall, the first sidewall and the second sidewall from physically contacting any portion of the support member.

In another embodiment, the intermediate material can comprise alumina.

In another embodiment, the upper wall, first sidewall and second sidewall can each comprise a thickness within a range from about 3 mm to about 7 mm.

In another embodiment, the upper wall, first sidewall and second sidewall can each comprise platinum.

In another embodiment, the support member can be positioned between the first sidewall and the second sidewall.

In another embodiment, a method of fabricating a glass ribbon from a quantity of molten material with the apparatus can comprise flowing the molten material within the molten material trough along a flow direction while the support trough of the support member supports a weight of the molten material. The method can further comprise flowing molten material from the molten material trough into a first stream of molten material flowing over the first support weir and a second stream of molten material flowing over the second support weir. The method can further comprise flowing the first stream of molten material on the first wedge surface along the downstream direction and the second stream of molten material on the second wedge surface along the downstream direction. The method can further [symbol] fusion drawing the first stream of molten material and the second stream of molten material from the root of the forming wedge as a glass ribbon.

In accordance with other embodiments, an apparatus can comprise a containment device including a surface defining a region extending in a flow direction of the containment device. The apparatus can further comprise a support member positioned to support a weight of the containment device. The support member can comprise a support material comprising a creep rate from 1×10⁻¹² l/s to 1×10⁻¹⁴ l/s under a pressure of from 1 MPa to 5 MPa at a temperature of 1400° C. The apparatus can further comprise a platinum wall that, in some embodiments, does not physically contact any portion of the support member.

In one embodiment, the support material can comprise a ceramic material.

In another embodiment, the ceramic material can comprise silicon carbide.

In accordance with other embodiments, an apparatus can comprise a containment device including a surface defining a region extending in a flow direction of the containment device. The apparatus can further comprise a silicon carbide support member positioned to support a weight of the containment device. The apparatus can further comprise a platinum wall that, in some embodiments, does not physically contact any portion of the support member.

In one embodiment, the containment device can comprise a platinum conduit comprising a peripheral wall defining the region. A first portion of the peripheral wall can comprise a slot extending through an outer peripheral surface of the peripheral wall. The slot can be in communication with the region.

In another embodiment, the support member can comprise a support surface defining an area receiving a second portion of the peripheral wall.

In another embodiment, the support surface can surround from about 25% to about 60% of the outer peripheral surface of the peripheral wall.

In another embodiment, a depth of the area receiving the second portion of the peripheral wall varies along a length of the slot.

In another embodiment, the depth of the area receiving t [symbol] portion of the peripheral wall can be greatest at a location of less than about 33% of the length of the slot measured in the flow direction of the containment device.

In another embodiment, the platinum conduit can comprise a first platinum conduit connected in series with a second platinum conduit at a joint. The depth of the area receiving the second portion of the peripheral wall can be greater at a lateral location of the joint than at an intermediate lateral location of the first platinum conduit and an intermediate lateral location of the second platinum conduit.

In another embodiment, the first portion of the peripheral wall can be opposite the second portion of the peripheral wall.

In another embodiment, the width of the slot can increase in the flow direction.

In another embodiment, a cross-sectional area of the region taken perpendicular to the flow direction can decrease in the flow direction.

In another embodiment, the outer peripheral surface of the peripheral wall can comprise a circular shape along a cross-section taken perpendicular to the flow direction.

In another embodiment, a thickness of the peripheral wall of the platinum conduit can be from about 3 mm to about 7 mm.

In another embodiment, the apparatus can further comprise a forming wedge positioned downstream from the slot of the conduit. The forming wedge can comprise a first wedge surface and a second wedge surface that converge in a downstream direction to form a root of the forming wedge.

In another embodiment, the platinum wall can comprise a first platinum sidewall defining the first wedge surface and a second platinum sidewall defining the second wedge surface.

In another embodiment, the support member can be positioned between the first platinum sidewall and the second platinum sidewall.

In another embodiment, an upstream end of an upstream portion of the first platinum sidewall can be attached to the peripheral wall of the platinum conduit at a first interface. Still further, an upstream end of an upstream portion of the second platinum sidewall can be attached to the peripheral wall of the platinum conduit at a second interface.

In another embodiment, the first interface and the second int [symbol] each located downstream from the slot of the platinum conduit.

In another embodiment, the upstream portion of the first platinum sidewall and the upstream portion of the second platinum sidewall can flare away from one another in the downstream direction.

In another embodiment, a method of flowing molten material with the apparatus can comprise flowing the molten material within the region in the flow direction. The method can further comprise flowing molten material through the slot from the region as a first stream of molten material and a second stream of molten material.

In another embodiment, the support member can comprise a support trough, a first support weir, and a second support weir. The support trough can be laterally positioned between the first support weir and the second support weir. The platinum wall can comprise an upper platinum wall at least partially defining a molten material trough positioned within the support trough and supported by the support trough. In some embodiments, the upper platinum wall does not physically contact any portion of the support member.

In another embodiment, the platinum wall can comprise a first platinum sidewall and a second platinum sidewall. The support member can be positioned between the first sidewall and the second sidewall.

In another embodiment, the apparatus can further comprise a forming wedge comprising a first wedge surface defined by a lower portion of the first platinum sidewall and a second wedge surface defined by a lower portion of the second platinum sidewall. The first wedge surface and the second wedge surface can converge in a downstream direction to form a root of the forming wedge.

In another embodiment, the platinum wall can comprise a thickness within a range from about 3 mm to about 7 mm.

In another embodiment, an intermediate material can prevent the platinum wall from physically contacting any portion of the support member.

In another embodiment, the intermediate material can comprise alumina.

In another embodiment, a method flowing molten material with the apparatus can comprise flowing the molten material within the molten material trough in the flow direction while the support trough of the support member [symbol] weight of the molten material. The method can further comprise flowing molten material from the molten material trough into a first stream of molten material flowing over the first support weir and a second stream of molten material flowing over the second support weir.

It is to be understood that both the foregoing general description and the following detailed description present embodiments of the present disclosure, and are intended to provide an overview or framework for understanding the nature and character of the embodiments as they are described and claimed. The accompanying drawings are included to provide a further understanding of the embodiments, and are incorporated into and constitute a part of this specification. The drawings illustrate various embodiments of the disclosure, and together with the description serve to explain the principles and operations thereof.

### BRIEF DESCRIPTION OF THE DRAWINGS

These and other features, embodiments and advantages of the present disclosure can be further understood when read with reference to the accompanying drawings, in which:

FIG. 1 schematically illustrates an exemplary embodiment of a glass manufacturing apparatus in accordance with embodiments of the disclosure;

FIG. 2 shows a perspective cross-sectional view of the glass manufacturing apparatus along line 2-2 of FIG. 1 showing a forming vessel in accordance with an embodiment of the disclosure;

FIG. 3 shows a cross-sectional view of the glass manufacturing apparatus along line 2-2 of FIG. 1;

FIG. 4 shows an elevational view of a forming vessel in accordance with another embodiment of the disclosure;

FIG. 5 shows a top view of the forming vessel along line 5-5 of FIG. 4;

FIG. 6 shows a cross-sectional view of the forming vessel along line 6-6 of FIG. 5;

FIG. 7 shows a cross-sectional view of another embodiment of the forming vessel along line 6-6 of FIG. 5;

FIG. 8 shows a cross-sectional view of the forming vessels [symbol] 8-8 of FIGS. 6 and 7;

FIG. 9 shows a cross-sectional view of further embodiments of the forming vessels along line 8-8 of FIGS. 6 and 7;

FIG. 10 shows a cross-sectional view of yet further embodiments of the forming vessels along line 10-10 of FIG. 6;

FIG. 11 shows a cross-sectional view of still further embodiments of the forming vessels along line 10-10 of FIG. 6; and

FIG. 12 shows a cross-sectional view of additional embodiments of the forming vessels along line 10-10 of FIG. 6.

### DETAILED DESCRIPTION

Embodiments will now be described more fully hereinafter with reference to the accompanying drawings in which exemplary embodiments are shown. Whenever possible, the same reference numerals are used throughout the drawings to refer to the same or like parts. However, this disclosure may be embodied in many different forms and should not be construed as limited to the embodiments set forth herein.

Apparatus and methods of the disclosure can provide glass ribbon that may be subsequently divided into glass sheets. In some embodiments, the glass sheets may be provided with four edges forming a parallelogram such as a rectangle (e.g., square), trapezoidal or other shape. In further embodiments, the glass sheets may be a round, oblong, or elliptical glass sheet with one continuous edge. Other glass sheets having two, three, five, etc. curved and/or straight edges may also be provided and are contemplated as being within the scope of the present description. Glass sheets of various sizes, including varying lengths, heights, and thicknesses, are also contemplated. In some embodiments, an average thickness of the glass sheets can be various average thicknesses between oppositely facing major surfaces of the glass sheet. In some embodiments, the average thickness of the glass sheet can be greater than 50 micrometers (μm), such as from about 50 μm to about 1 millimeter (mm), such as from about 100 μm to about 300 μm although other thicknesses may be provided in further embodiments. Glass sheets can be used in a wide range of display applications such as, but not limited to, liquid crystal displays (LCDs), electrophoretic displays (EPD), organic light emitting diode displays (OLEDs), and plas [symbol] panels (PDPs).

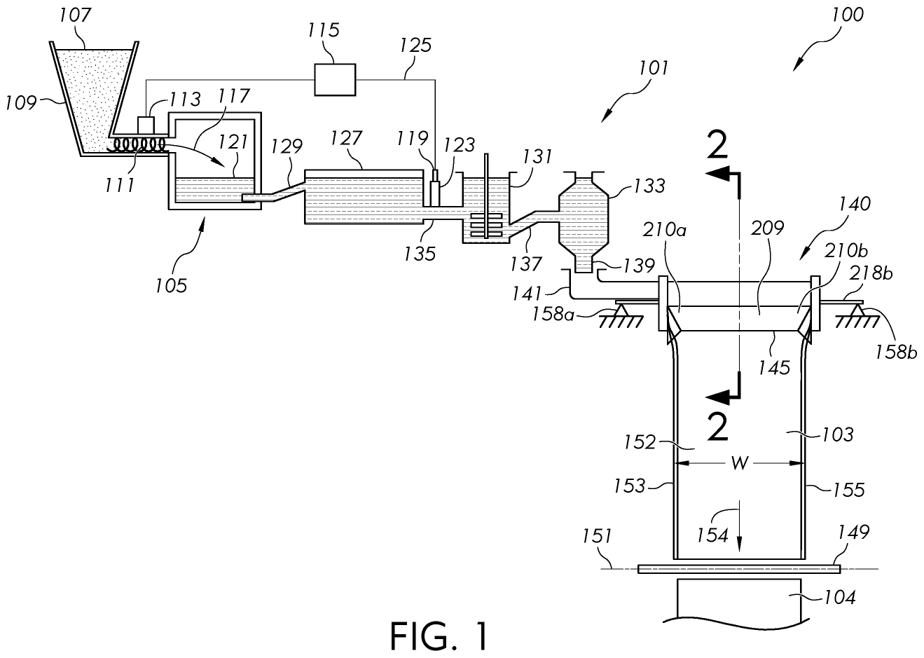

As schematically illustrated in FIG. 1, in some embodiments, an exemplary glass manufacturing apparatus 100 can include a glass forming apparatus 101 including a forming vessel 140 designed to produce a glass ribbon 103 from a quantity of molten material 121. In some embodiments, the glass ribbon 103 can include a central portion 152 disposed between opposite, relatively thick edge beads formed along a first outer edge 153 and a second outer edge 155 of the glass ribbon 103. Additionally, in some embodiments, a glass sheet 104 can be separated from the glass ribbon 103 along a separation path 151 by a glass separator 149 (e.g., scribe, score wheel, diamond tip, laser, etc.). In some embodiments, before or after separation of the glass sheet 104 from the glass ribbon 103, the relatively thick edge beads formed along the first outer edge 153 and the second outer edge 155 can be removed to provide the central portion 152 as a high-quality glass sheet 104 having a uniform thickness.

In some embodiments, the glass manufacturing apparatus 100 can include a melting vessel 105 oriented to receive batch material 107 from a storage bin 109. The batch material 107 can be introduced by a batch delivery device 111 powered by a motor 113. In some embodiments, an optional controller 115 can be operated to activate the motor 113 to introduce a desired amount of batch material 107 into the melting vessel 105, as indicated by arrow 117. The melting vessel 105 can heat the batch material 107 to provide molten material 121. In some embodiments, a glass melt probe 119 can be employed to measure a level of molten material 121 within a standpipe 123 and communicate the measured information to the controller 115 by way of a communication line 125.

Additionally, in some embodiments, the glass manufacturing apparatus 100 can include a first conditioning station including a fining vessel 127 located downstream from the melting vessel 105 and coupled to the melting vessel 105 by way of a first connecting conduit 129. In some embodiments, molten material 121 can be gravity fed from the melting vessel 105 to the fining vessel 127 by way of the first connecting conduit 129. For example, in some embodiments, gravity can drive the molten material 121 to pass through an interior pathway of the first connecting conduit 129 from the melting vessel 105 to the fining vessel 127. Additionally, in some embodiments, bubbles can be removed from the molten material 121 [symbol] fining vessel 127 by various techniques.

In some embodiments, the glass manufacturing apparatus 100 can further include a second conditioning station including a mixing chamber 131 that can be located downstream from the fining vessel 127. The mixing chamber 131 can be employed to provide a homogenous composition of molten material 121, thereby reducing or eliminating inhomogeneity that may otherwise exist within the molten material 121 exiting the fining vessel 127. As shown, the fining vessel 127 can be coupled to the mixing chamber 131 by way of a second connecting conduit 135. In some embodiments, molten material 121 can be gravity fed from the fining vessel 127 to the mixing chamber 131 by way of the second connecting conduit 135. For example, in some embodiments, gravity can drive the molten material 121 to pass through an interior pathway of the second connecting conduit 135 from the fining vessel 127 to the mixing chamber 131.

Additionally, in some embodiments, the glass manufacturing apparatus 100 can include a third conditioning station including a delivery vessel 133 that can be located downstream from the mixing chamber 131. In some embodiments, the delivery vessel 133 can condition the molten material 121 to be fed into an inlet conduit 141. For example, the delivery vessel 133 can function as an accumulator and/or flow controller to adjust and provide a consistent flow of molten material 121 to the inlet conduit 141. As shown, the mixing chamber 131 can be coupled to the delivery vessel 133 by way of a third connecting conduit 137. In some embodiments, molten material 121 can be gravity fed from the mixing chamber 131 to the delivery vessel 133 by way of the third connecting conduit 137. For example, in some embodiments, gravity can drive the molten material 121 to pass through an interior pathway of the third connecting conduit 137 from the mixing chamber 131 to the delivery vessel 133. As further illustrated, in some embodiments, a delivery pipe 139 (e.g., downcomer) can be positioned to deliver molten material 121 to the inlet conduit 141 of the forming vessel 140.

Embodiments of the disclosure can provide an apparatus with a containment device including a surface defining a region extending in a flow direction of the containment device. In some embodiments, the containment device can be configured to contain molten material that can flow in the flow direction of the containment device. In some embodiments, the containment device can [symbol] forming vessels in accordance with various embodiments of the disclosure. For example, containment devices comprising forming vessels can include but are not limited to a forming wedge for fusion drawing the glass ribbon, a slot for slot drawing the glass ribbon, a trough, a pipe with an upper slot, and/or press rolls for press rolling the glass ribbon.

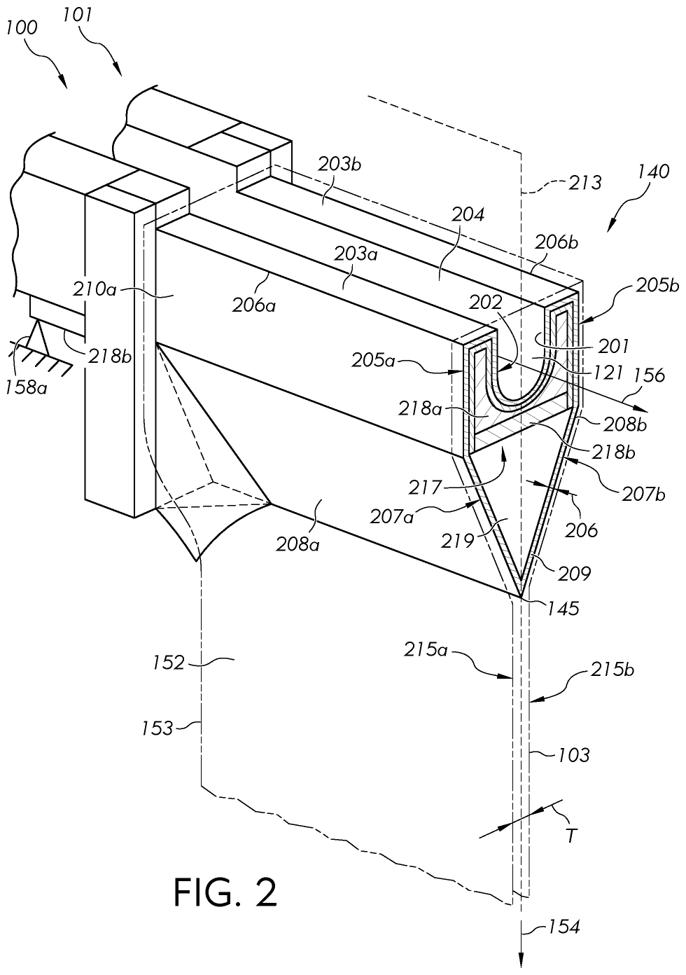

As illustrated in FIGS. 1-3, embodiments disclosed herein include those in which the containment device can comprise the forming vessel 140 of the glass forming apparatus 101. As shown in FIG. 2, the containment device includes a surface 202 that can define a molten material trough 201 of the forming vessel 140 that extends in a flow direction 156 of the containment device. The molten material trough 201 can be oriented to receive the molten material 121 from the inlet conduit 141. For illustrative purposes, cross-hatching of the molten material 121 is removed from FIG. 2 for clarity. In some embodiments, the depth of the molten material trough 201 may decrease in the flow direction 156 to provide for a desired flow distribution of molten material 121 flowing over molten material weirs 203a, 203b of the forming vessel 140 along a length of the molten material trough 201.

In some embodiments, the glass forming apparatus can include at least one wall that can comprise an upper wall 204. The upper wall 204 can at least partially define the molten material trough 201 and the molten material weirs 203a, 203b. The at least one wall can further include a first sidewall 208a and a second sidewall 208b. The first sidewall 208a can comprise an upper portion attached to a first side 206a of the upper wall 204. The second sidewall 208b can comprise an upper portion attached to a second side 206b of the upper wall 204.

The forming vessel 140 can include a forming wedge 209 comprising a first wedge surface 207a defined by a lower portion of the first sidewall 208a and a second wedge surface 207b defined by a lower portion of the second sidewall 208b. The first wedge surface 207a and the second wedge surface 207b can extend between opposite ends 210a, 201b (See FIG. 1). In some embodiments, the first wedge surface 207a and the second wedge surface 207b can be downwardly inclined and converge in a downstream draw direction 154 to form a root 145 of the forming wedge 209. A draw plane 213 of the glass manufacturing apparatus 100 can extend through the root 145 along the draw direction 154. In some embodiments, the glass ribbon 103 can be drawn in the draw direction 154 along the draw plan [symbol] shown, the draw plane 213 can bisect the forming wedge 209 through the root 145 although, in some embodiments, the draw plane 213 can extend at other orientations relative to the root 145.

In some embodiments, the at least one wall such as the upper wall 204, the first sidewall 208a and/or the second sidewall 208b can comprise platinum (e.g., a platinum alloy), or other refractory designed to contain and/or define travel paths for molten material contacting the walls. In order to reduce material costs of the forming vessel 140, the thickness 206 of the at least one wall, in some embodiments, may be provided within a range of about 3 mm to about 7 mm although other thicknesses may be used in further embodiments. The at least one wall may comprise a platinum wall comprising a platinum or platinum alloy although other materials may be provided that are compatible with the molten material and provide structural integrity at the elevated temperatures of the molten material. In some embodiments, part of the at least one wall may comprise platinum and/or platinum alloy. In further embodiments, the entire at least one wall may comprise or consist essentially of platinum or a platinum alloy.

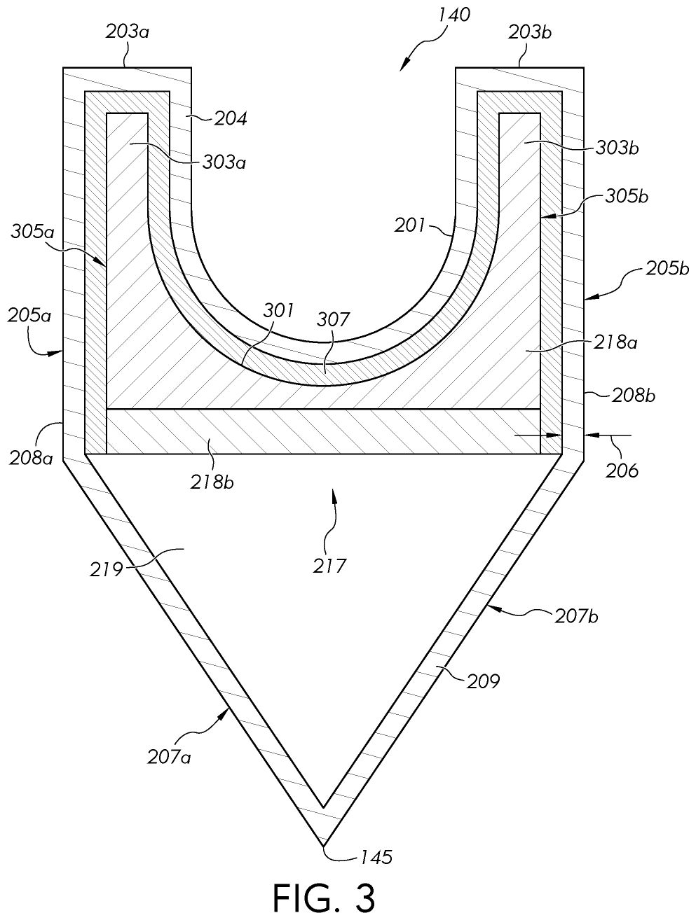

Embodiments of the forming vessel 140 include a support member 217 to help maintain the shape of the upper wall 204 and/or sidewalls 208a, 208b. In some embodiments, the support member 217 may be positioned between the first sidewall 208a and the second sidewall 208b to support a weight of the containment device and molten material contained by the containment device and help maintain the desired distance between the sidewalls. In further embodiments, referring to FIG. 3, the support member 217 may comprise a support trough 301, a first support weir 303a, and a second support weir 303b. As shown, the support trough 301 can be laterally positioned between the first support weir 303a and the second support weir 303b.

The support member 217 can be designed to support at least the upper wall 204 and can further support portions of the first sidewall 208a, and the second sidewall 208b. For example, the molten material trough 201 defined by the upper wall 204 can be positioned within the support trough 301 and supported by the support trough 301 of the support member 217. As such, the support trough 301 can help maintain the shape of the molten material trough 201 defined by the upper wall 204 against deformation due to creep and/or mechanical stress that may [symbol] occur without support from the support trough 301.

Furthermore, the molten material weirs 203a, 203b defined by the upper wall 204 can be further supported by the support weirs 303a, 303b of the support member 217. Furthermore, outer surfaces 305a, 305b can support portions of the first sidewall 208a and the second sidewall 208b. For instance, the outer surfaces 305a, 305b of the support weirs 303a, 303b can support upper portions of the first sidewall 208a and the second sidewall 208b to maintain the orientation of the upper surfaces 205a, 205b of the sidewalls 208a, 208b. Although not shown, in addition or as an alternative, the support member 217 can support the lower portions of the sidewalls 208a, 208b defining the wedge surfaces 207a, 207b to help properly maintain the orientation of the wedge surfaces. However, material costs may be saved by eliminating the support member 217 from the interior of the forming wedge 209 since the triangular configuration provided by the lower portions of the sidewall and the base of the support member 217 can provide sufficient structural integrity to maintain the proper orientation of the wedge surfaces 207a, 207b.

In one or more embodiments, the support member 217 such as the portions of the support member 217 defining the support trough 301, first support weir 303a and/or second support weir 303b can comprise a support material with a creep rate from 1×10⁻¹² l/s to 1×10⁻¹⁴ l/s under a pressure of from 1 MPa to 5 MPa at a temperature of 1400° C. Such a support material can provide sufficient support for a trough and molten material carried within the trough at high temperatures (e.g., 1400° C.) with minimal creep to provide a forming vessel 140 that minimizes use of platinum or other expensive refractory materials ideal for physically contacting the molten material without contaminating the molten material while providing a support member 217 fabricated from a relatively less expensive material that can withstand large stresses under the weight of the wall (e.g., platinum wall) and molten material carried by the surfaces of the wall. At the same time, the support member 217 fabricated from the material discussed above can withstand creep under high stress and temperature to allow maintenance of the position and shape of the molten material weirs, molten material trough and outer surfaces of the sidewalls.

The support material of the support member 217 can comprise a wide range of materials. In some embodiments, the support material of the support member 217 can comprise a ceramic material such as ceramic material a [symbol] from 1×10⁻¹² l/s to 1×10⁻¹⁴ l/s under a pressure of from 1 MPa to 5 MPa at a temperature of 1400° C. In further embodiments, the support material can comprise silicon carbide with a creep rate from 1×10⁻¹² l/s to 1×10⁻¹⁴ l/s under a pressure of from 1 MPa to 5 MPa at a temperature of 1400° C.

In some embodiments, the material of the wall may be incompatible for physical contact with the material of the support member 217. For example, in some embodiments, the wall can comprise platinum (e.g., platinum or platinum alloy) and the support member 217 can comprise silicon carbide that may corrode or otherwise chemically react with the platinum if the wall physically contacts the support member. As such, in some embodiments, to avoid physical contact between incompatible materials, any portion of the wall (e.g., upper wall 204, first sidewall 208a, second sidewall 208b) may be prevented from physically contacting any portion of the support member 217. As shown, for example, in FIG. 3, the upper wall 204, first sidewall 208a, and second sidewall 208b are spaced from physically contacting any portion of the support member 217. Various techniques can be used to space the wall from the support member. For example, pillars or ribs may be provided to provide spacing.

In further embodiments, as shown, a layer of intermediate material 307 may be provided between the wall and the support member 217 to space the wall from contacting the support member 217. In some embodiments, the layer of intermediate material 307 may be continuously provided between all portions of the wall and adjacent spaced portions of the support member 217. Providing a continuous layer of intermediate material 307 can facilitate even support across all portions of the wall by the surface of the support member 217 spaced from the wall.

As shown, in some embodiments, the molten material trough 201 can be positioned within the support trough 301 and supported by the support trough 301, wherein the upper wall 204 can be spaced from physically contacting any portion of the support member 217. For instance, as shown, the layer of intermediate material 307 may be provided as a continuous layer of intermediate material to space all portions of the upper wall 204 defining the molten material trough 201 from physically contacting any portion of the support member 217 (e.g., the portions of the support member 217 defining the support trough 301). As such, the layer of intermediate material 307 can provide continuous support of the portions o [symbol] wall 204 defining the molten material trough 201 to increase strength and resistance to deformation and creep of the molten material trough 201.

As further illustrated, the layer of intermediate material 307 may be provided as a continuous layer of intermediate material to space all portions of the upper wall 204 defining the molten material weirs 203a, 203b from physically contacting any portion of the support member 217 (e.g., the portions of the support member 217 defining the support weirs 303a, 303b). As such, the layer of intermediate material 307 can provide continuous support of the portions of the upper wall 204 defining the molten material weirs 203a, 203b to increase strength and resistance to deformation and creep of the molten material weirs 203a, 203b.

As further illustrated, the layer of intermediate material 307 may be provided as a continuous layer of intermediate material to space all portions of the first sidewall 208a and the second sidewall 208b defining the upper surfaces 205a, 205b and/or the wedge surfaces 207a, 207b from physically contacting any portion of the support member 217 (e.g., the surfaces of the support member 217 facing the sidewalls 208a, 208b) As such, the layer of intermediate material 307 can provide continuous support of the portions of the sidewalls 208a, 208b associated with the support member 217 to increase the strength and resistance to deformation and creep of the sidewalls 208a, 208b associated with the support member 217.

Various materials can be used as the intermediate material depending on the materials of the wall and the support member. For instance, the material can comprise alumina or other material that is compatible for contacting platinum and silicon carbide under high temperature and pressure conditions associated with containing and guiding molten material with the forming vessel 140. Thus, in some embodiments, a platinum or platinum alloy wall (e.g., upper wall 204, first sidewall 208a, second sidewall 208b) can be spaced from physically contacting any portion of a support member 217 comprising silicon carbide by way of a layer of intermediate material comprising alumina.

In some embodiments, methods of flowing molten material 121 with the glass manufacturing apparatus 100 can include flowing the molten material 121 within the molten material trough 201 in the flow direction 156 while the support trough 301 of the support member 217 supports a weight of the molten material 121. The molten material 121 can then overflow from the molten material trou [symbol] simultaneously flowing over corresponding molten material weirs 203a, 203b and downward over the upper surfaces 205a, 205b of the sidewalls 208a, 208b. Specifically, a first stream of molten material may flow over the first support weir 303a while contacting the outer surface of the first molten material weir 203a supported by the first support weir 303a. Furthermore, a second stream of molten material may flow over the second support weir 303b while contacting the outer surface of the second molten material weir 203b supported by the second support weir 303b. The first stream of molten material may continue to flow along the downwardly inclined first wedge surface 207a of the forming wedge 209 and the second stream of molten material may continue to flow along the downwardly inclined wedge surface 207b of the forming wedge 209. The first and second streams of molten material may each therefore flow along the downstream direction 154 while converging together at the root 145 of the forming wedge 209. The converging streams of molten material may then meet at the root 145 and drawn off the root 145 of the forming vessel 140, wherein the streams of molten material converge and fuse into the glass ribbon 103.

The glass ribbon 103 can then be fusion drawn off the root 145 in the draw plane 213 along the draw direction 154. In some embodiments, the glass separator 149 (see FIG. 1) can then subsequently separate the glass sheet 104 from the glass ribbon 103 along the separation path 151. As illustrated, in some embodiments, the separation path 151 can extend along the width “W” of the glass ribbon 103 between the first outer edge 153 and the second outer edge 155. Additionally, in some embodiments, the separation path 151 can extend perpendicular to the draw direction 154 of the glass ribbon 103. Moreover, in some embodiments, the draw direction 154 can define a direction along which the glass ribbon 103 can be fusion drawn from the forming vessel 140. In some embodiments, the glass ribbon 103 can include a speed as it traverses along draw direction 154 of ≥50 mm/s, ≥100 mm/s, or ≥500 mm/s, for example, from about 50 mm/s to about 500 mm/s, such as from about 100 mm/s to about 500 mm/s, and all ranges and subranges therebetween.

Throughout the embodiments of the disclosure, the width “W” of the glass ribbon 103 can, for example, be greater than or equal to about 20 mm, such as greater than or equal to about 50 mm, such as greater than or equal to about 100 mm, such as greater than or equal to about 500 mm, such as greater tha [symbol] to about 1000 mm, such as greater than or equal to about 2000 mm, such as greater than or equal to about 3000 mm, such as greater than or equal to about 4000 mm, although other widths less than or greater than the widths mentioned above can be provided in further embodiments. For example, in some embodiments, the width “W” of the glass ribbon 103 can be from about 20 mm to about 4000 mm, such as from about 50 mm to about 4000 mm, such as from about 100 mm to about 4000 mm, such as from about 500 mm to about 4000 mm, such as from about 1000 mm to about 4000 mm, such as from about 2000 mm to about 4000 mm, such as from about 3000 mm to about 4000 mm, such as from about 20 mm to about 3000 mm, such as from about 50 mm to about 3000 mm, such as from about 100 mm to about 3000 mm, such as from about 500 mm to about 3000 mm, such as from about 1000 mm to about 3000 mm, such as from about 2000 mm to about 3000 mm, such as from about 2000 mm to about 2500 mm, and all ranges and subranges therebetween.

As shown in FIG. 2, the glass ribbon 103 can be drawn from the root 145 with a first major surface 215a of the glass ribbon 103 and a second major surface 215b of the glass ribbon 103 facing opposite directions and defining a thickness “T” (e.g., average thickness) of the glass ribbon 103. In some embodiments throughout the present disclosure, forming vessels of the disclosure can provide that the thickness “T’ of the glass ribbon 103 can be less than or equal to about 2 millimeters (mm), less than or equal to about 1 millimeter, less than or equal to about 0.5 millimeters, for example, less than or equal to about 300 micrometers (μm), less than or equal to about 200 micrometers, or less than or equal to about 100 micrometers, although other thicknesses may be provided in further embodiments. For example, in some embodiments, the thickness “T’ of the glass ribbon 103 can be from about 50 μm to about 750 μm, from about 100 μm to about 700 μm, from about 200 μm to about 600 μm, from about 300 μm to about 500 μm, from about 50 μm to about 500 μm, from about 50 μm to about 700 μm, from about 50 μm to about 600 μm, from about 50 μm to about 500 μm, from about 50 μm to about 400 μm, from about 50 μm to about 300 μm, from about 50 μm to about 200 μm, from about 50 μm to about 100 μm, including all ranges and subranges of thicknesses therebetween. In addition, the glass ribbon 103 can include a variety of compositions including, but not limited to, soda-lime glass, borosilicate glass, alumino-borosilicate gla [symbol] containing glass, or alkali-free glass.

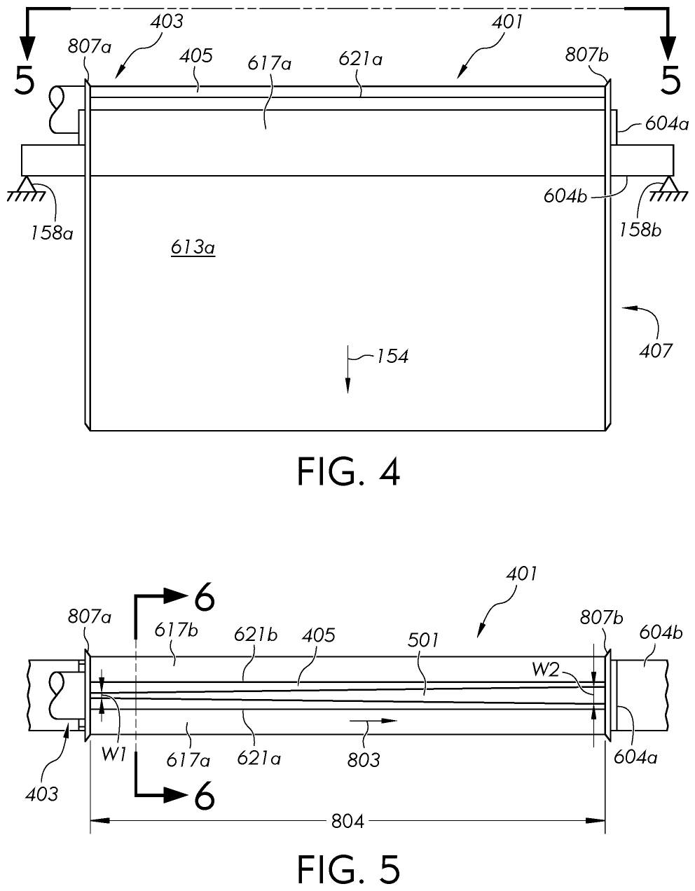

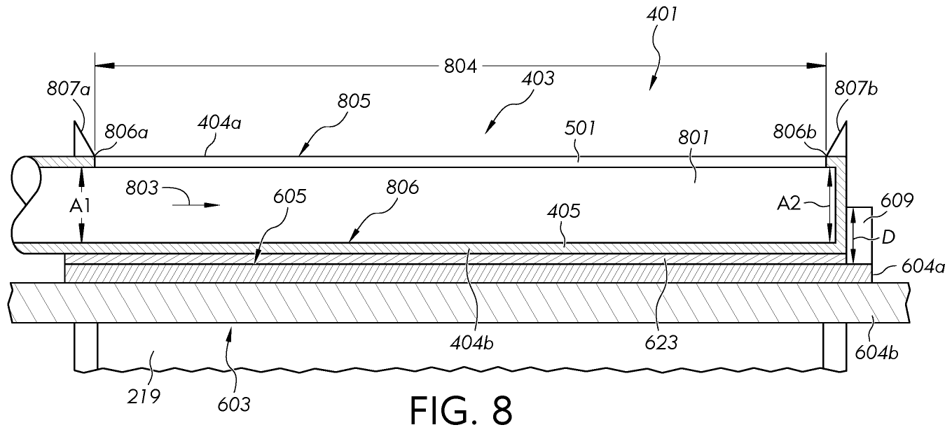

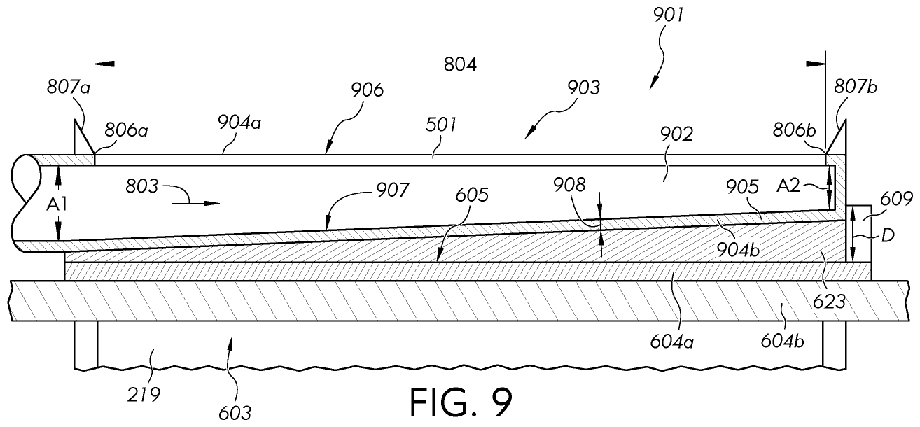

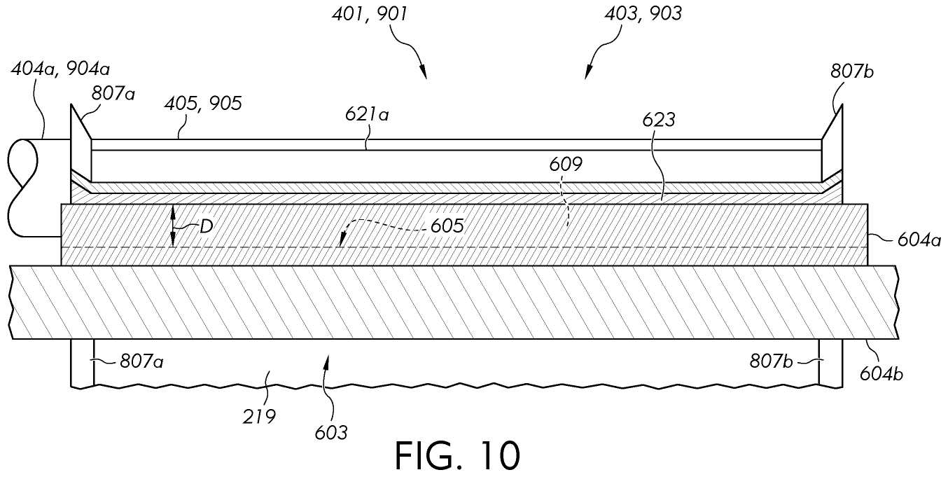

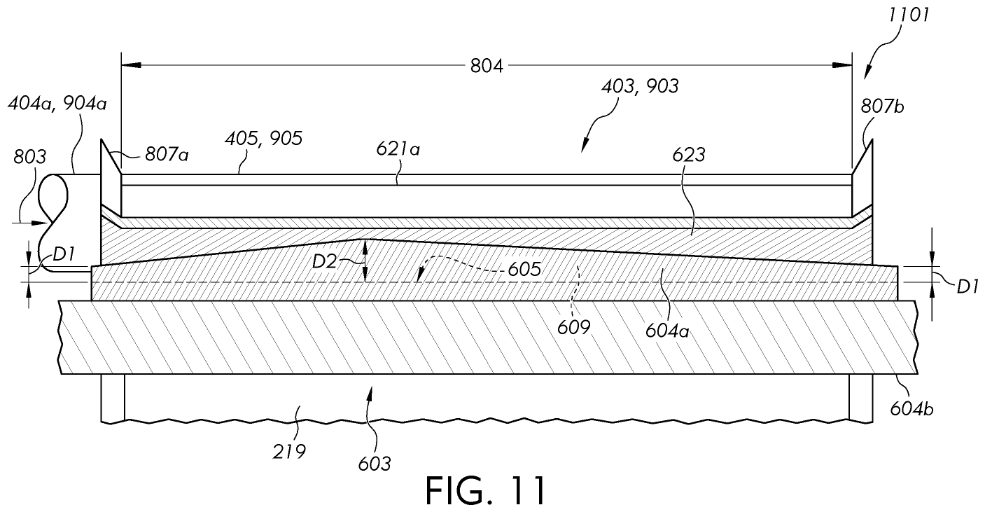

FIGS. 4-12 illustrate further embodiments of a containment device that can comprise a forming vessel 401, 701, 901, 1101, 1201 that may be provided in place of the forming vessel 140 shown in the glass forming apparatus 101 of FIG. 1. The forming vessel 401, 701, 901, 1101, 1201 can comprise a conduit 403, 903 comprising a peripheral wall 405, 905 comprising an inner surface 806, 907 of defining a region 801, 902. The region 801, 902 can extend in a flow direction 803 (see FIGS. 8-9) of the conduit 403, 903.

A first portion 404a, 904a of the peripheral wall 405, 905 can comprise a slot 501. As shown in FIG. 8, the slot 501 comprise a through-slot that extends through the peripheral wall 405, 905. The slot 501 can be open an outer peripheral surface 805, 906 and the inner surface 806, 907 of the peripheral wall 405, 905 to provide communication between the region 801, 902 and the outer peripheral surface 805, 906 of the peripheral wall 405, 905. As shown in FIGS. 5, 8 and 9, the slot 501 of any of the embodiments of the disclosure can optionally comprise a continuous slot extending a length 804 between inner interface locations 806a, 806b of opposite edge directors 807a, 807b and the outer peripheral surface 805, 906 of the peripheral wall 405, 905 of the conduit 403, 903. Although not shown, the slot 501 may optionally comprise a plurality of intermittent slots or openings along the path of the illustrated slot to help increase the strength of the conduit. Alternatively, a continuous slot can be provided to help provide even volumetric flow rate of molten material through the slot 501 along the length 804 of the slot 501 in use.

Although not shown, the width of the slot 501 can, for example, be same along the length 804 of the slot in any embodiment of the disclosure. Alternatively, in any of the embodiments of the disclosure, the width of the slot can vary along the length 804. For instance, as shown in FIG. 5, the width of the slot 501 can increase, such as intermittently or continuously increase from a first width W1 to a second width W2 along the flow direction 803 wherein the second width W2 can be greater than the first width W1. Furthermore, if provided with a continuous increase in width, the slot width can optionally continuously increase at a constant rate although continuously increasing at a changing rate can also be provided in further embodiments. For instance, as shown in FIG. 5, the slot 501 can optionally increase continuously at a constant rate in the flow direction 803 from the first width [symbol] second width W2. Increasing, such as continuously increasing the width of the slot 501 in the flow direction 803, can help provide substantially the same volumetric flow rate of molten material through the slot 501 along the length 804 of the slot 501 in use.

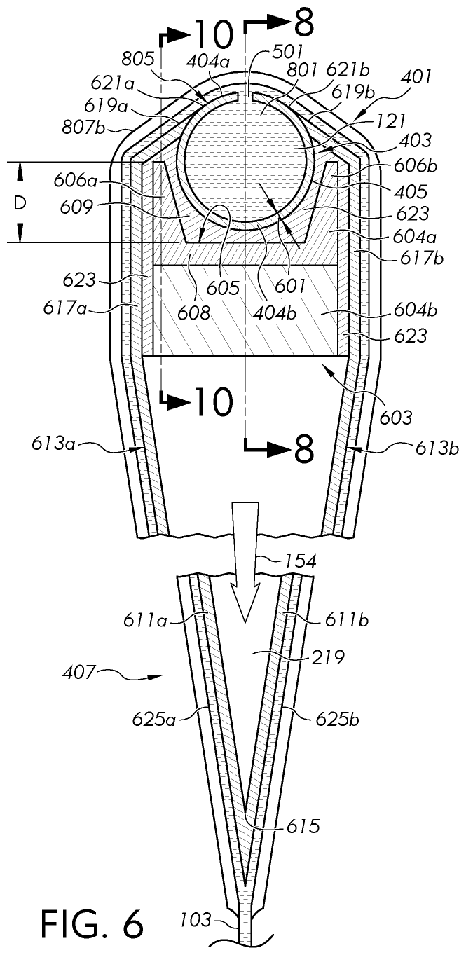

As can be appreciated in FIGS. 6-9, the slot 501 can be provided in first portion 404a, 904a of the peripheral wall 405, 905 at the uppermost apex of the conduit 403, 903 wherein the slot 501 extends along a vertical plane that bisects the conduit and the slot 501 such as the draw plane 213 that can also bisect the root of the forming wedge. Providing the slot 501 along the uppermost apex can help evenly divide the molten material exiting the slot 501 into oppositely flowing streams. Although not shown, a plurality of slots may be provided that extend such that the vertical plane that bisects the conduit can also bisect the slot or can be parallel to the slot. For example, one or more pairs of slots may be symmetrically disposed about the vertical plane that bisects the conduit, wherein each slot of the pair of slots provides a dedicated flow of molten material at each corresponding side of the conduit. Although not required, symmetrically disposing the pair of slots about the vertical plane can help provide similar flow rates of molten material flowing from each corresponding side of the conduit.

The peripheral wall 405, 905 of the conduit 403, 903 may comprise a platinum wall comprising a platinum or platinum alloy although other materials may be provided that are compatible with the molten material and provide structural integrity at elevated temperatures. In further embodiments, the entire peripheral wall 405, 905 may comprise or consist essentially of platinum or a platinum alloy. As such, in some embodiments, the containment device can comprise a platinum conduit 403, 903 comprising the peripheral wall 405, 905 defining the region 801, 902. Furthermore, the platinum conduit 403, 903, if provided, can include the slot 501, as described above, that can extend through the outer peripheral surface 805, 906 of the peripheral wall 405, 905. As mentioned above, the slot 501 can comprise a through slot in communication with the region 801, 902 and the outer peripheral surface 805, 906 of the peripheral wall 405, 905.

In order to reduce material costs of the conduit (e.g., platinum conduit 403, 903), a thickness 601, 908 of the peripheral wall 405, 905 of the conduit can, for example, be from about 3 mm to about 7 mm although other thick [symbol] be used in further embodiments. Providing the conduit with the thickness 601, 908 within the range of from about 3 mm to about 7 mm can provide a thickness that is large enough to provide a desired level of structural integrity for the conduit while also providing a thickness that can be minimized to reduce the costs of the materials to produce the conduit (e.g., platinum conduit).

The peripheral wall 405, 905 of the conduit 403, 903 can comprise a wide range of sizes, shapes and configurations to reduce manufacturing and/or assembly costs and/or increase the functionality of the conduit 403, 903. For instance, as shown, the outer peripheral surface 805, 906 and/or the inner surface 806, 907 of the peripheral wall 405, 905 may comprise a circular shape along a cross-section taken perpendicular to the flow direction 803 although other curvilinear shapes (e.g., oval) or polygonal shapes may be provided in further embodiments. Providing a curvilinear shape, such as a circular shape of both the outer peripheral surface and the inner peripheral surface can provide a peripheral wall with a constant thickness and can provide a wall with relatively high structural strength and help prevent consistent flow of molten material through the region 801 of the conduit 403, 903.

The cross-sectional area of the region taken perpendicular to the flow direction of any of the embodiments of the disclosure can remain the same along the flow direction. For instance, as shown in FIG. 8, the cross-sectional area of the region 801 taken perpendicular to the flow direction 803 can remain the same in the flow direction 803. Indeed, as shown in FIG. 8, the cross-sectional area A1 of the region 801 at an upstream location can be substantially equal to a cross-sectional area A2 of the region 801 at a downstream location. Furthermore, as will be appreciated from FIGS. 6-8, the outer peripheral surface 805 and/or the inner surface 806 of the conduit 403 can include an identical circular shape (or other shape) along the length 804. In such embodiments, the volumetric flow rate through the slot 501 at various locations along the slot can be controlled (e.g., maintained substantially the same) by increasing the width of the slot 501 in the flow direction 803 as discussed above.

The cross-sectional area of the region taken perpendicular to the flow direction of any of the embodiments of the disclosure can alternatively vary along the flow direction. For instance, as shown in FIG. 9, the cross-sectional area of the region 902 taken perpendicular to the flow direction 803 of the condu [symbol] decrease in the flow direction 803 of the conduit 903. Indeed, as shown in FIG. 9, the cross-sectional area A1 of the region 902 at an upstream location can be greater than a cross-sectional area A2 of the region 801 at a downstream location. In some embodiments, as shown, the cross-sectional area can continuously decrease from A1 to A2 (e.g., at a constant rate) along the flow direction 803 although the cross-sectional area may decrease at a varying rate or provide step decreases in cross-sectional area. Providing a continuous decrease in cross-sectional area at a constant rate along the flow direction 803 can provide a more consistent flow rate of molten material through the slot 501 along the length of the slot. Furthermore, as will be appreciated from FIG. 9, the outer peripheral surface 906 and/or the inner surface 907 of the conduit 903 can include a geometrically similar cross-sectional circular shape (or other shape) along the length 804. In such embodiments, the volumetric flow rate through the slot 501 at various locations along the slot can be controlled (e.g., maintained substantially the same) by the decreasing cross-sectional area of the region 902 along the flow direction 803 either alone or in combination with increasing the width of the slot 501 in the flow direction 803 as discussed above.

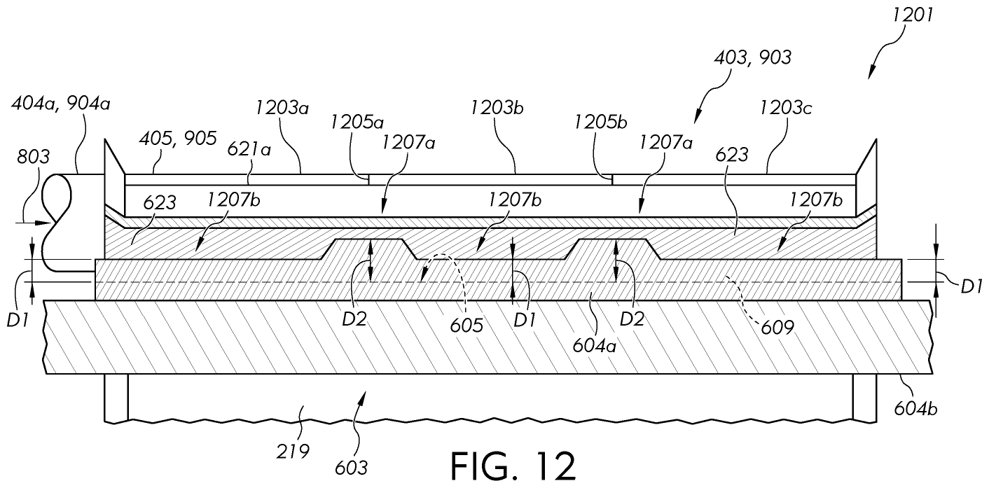

The conduits 403, 903 (e.g., platinum conduits) of any of the embodiments of the disclosure can comprise a continuous conduit although segmented conduits may be provided in further embodiments. For instance, as illustrated in FIGS. 8-11, the conduit 403, 903 of the can comprise a continuous conduit that is not segmented along the length of the conduit. Such a continuous conduit may be beneficial to provide a seamless conduit with increased structural strength. In some embodiments, a segmented conduit may be provided. For instance, as shown in FIG. 12, the conduit 403, 903 (e.g., platinum conduit) of the forming vessel 1201 can optionally comprise conduit segments 1203a, 1203b, 1203c that can be connected together in series at joints 1205a, 1205b between abutting ends of pairs of adjacent conduit segments. In some embodiments, the joints may comprise welded joints to integrally join the conduit segments 1203a, 1203b, 1203c as an integral conduit extending along the length of the slot 501. Providing the conduit as a series of conduit segments 1203a, 1203b, 1203c may simplify fabrication of conduits in some applications.

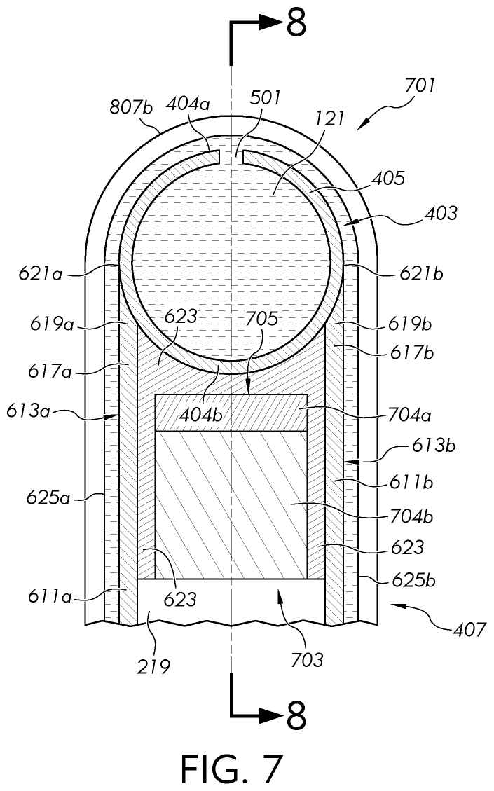

Embodiments of the forming vessel 401, 701, 901, 1 [symbol] include a support member 603, 703 positioned to support a weight of the conduit 403, 903 and the molten material within the region 801, 902 or otherwise being supported by the forming vessel. As shown in FIG. 7, the support member can include an upper surface 705 designed to support the weight of the conduit 403, 903 and associated molten material. The upper support surface 705 is shown as a flat surface although other surfaces, such as a concave surface may be provided in further embodiments. If provided as a concave surface, the concave surface may be geometrically similar to a convex surface segment of the outer peripheral surface 805, 906 of the conduit 403, 903 to provide a cradle to help position the conduit relative to the support surface 705 and distribute the weight of the conduit more evenly along the support surface 705.

In further embodiments, in addition to supporting the weight of the conduit 403, 903 and the molten material associated with the conduit, the support member may be configured to help maintain the shape and/or dimensions of the conduit 403, 903 such as the shape and dimensions of the slot 501. For example, embodiments of the forming vessel 401, 901, 1101, 1201 can include a support member 603 comprising a support surface 605 defining an area 609 receiving a second portion 404b, 904b of the peripheral wall 405, 905. As shown in FIGS. 6, 8 and 9, the first portion 404a, 904a of the peripheral wall 405, 905 can be opposite the second portion 404b, 904b of the peripheral wall 405, 905. Consequently, the lowest portions of the conduit 403, 903 associated with the second portion 404b, 904b of the peripheral wall 405, 905 can be received and seated within the area 609 defined by the support surface 605 of the support member 603. In some embodiments, as shown in FIG. 6, the support surface 605 of the support member 603 can surround from about 25% to about 60% of the outer peripheral surface 805, 906 of the peripheral wall 405, 905 of the conduit 403, 903. Providing the support surface surrounding from about 25% to about 60% of the outer peripheral surface 805, 906 can help prevent lateral deformation of opposite portions of the peripheral wall 405, 905 of the conduit 403, 903 that may otherwise undesirably increase a width of the slot 501. The surrounding of at least a portion of the outer peripheral surface 805, 906 can help prevent deformation to maintain the dimensions of the width of the slot 501 along the length 804 of the slot, thereby providing consistent flow characteristics of molten material through the slot 501 in use. Furthermore, the cross-sectional shape of the conduit 403, 903 may also be maintained at a desired predetermined shape to hel [symbol] desired attributes of molten material traveling along the flow direction 803.

As shown in FIGS. 6 and 8-10 a depth “D” of the area 609 receiving the second portion 404b, 904b of the peripheral wall 405, 905 can remain substantially the same along the length 804 of the slot 501. Alternatively, as shown in FIGS. 11-12, a depth of the area 609 receiving the second portion 404b, 904b of the peripheral wall 405, 905 can vary along the length 804 of the slot 501. Such embodiments can minimize the amount of material used to form the support member at areas that require less lateral support while further providing increased depth for additional lateral support at locations where further lateral support may be desired. For example, as shown in FIG. 11, the depth of the area 609 receiving the second portion 404b, 904b of the peripheral wall can be greatest at depth “D2” at a location of less than or equal to about 33% of the length 804 of the slot 501 measured in the flow direction 803 of the conduit 403, 903. In some embodiments, the depth of the peripheral wall can be greatest at a location of less than or equal to about 33% of the axial length of the conduit 403, 903 in the flow direction 803 from a symmetrical centerline of an upper end of the inlet conduit 141 (see FIG. 1). Providing the increased depth “D2” at the location less than about 33% of the axial length of the conduit 403, 903, such as less than about 33% of the length 804 of the slot 501, as discussed above, can maximize lateral support of the conduit 403, 903 at the location where stress is maximized while reducing the depth (e.g., at depth “D1”) at other locations that require less lateral support to maintain the dimensions of the conduit 403, 903 such as the width of the slot 501.

As mentioned previously, as shown in FIG. 12, the conduit 403, 903 (e.g., platinum conduit) of the forming vessel 1201 can optionally comprise conduit segments 1203a, 1203b, 1203c that can be connected together in series at joints 1205a, 1205b between abutting ends of pairs of adjacent conduit segments. In such embodiments, as shown in FIG. 12, the depth “D2” of the area 609 receiving the second portion 404b, 904b of the peripheral wall 405, 905 can be greater at a lateral location 1207a of the joint 1205a, 1205b than at an intermediate location 1207b of the conduit segments 1203a, 1203b, 1203c. Providing the increased depth “D2” at the lateral locations 1207a of the joints 1205a, 1205b, as discussed above, can maximize lateral support of the conduit 403, 903 at the location where stress concentrations occur due to any discontinuities at the joint while reducing t [symbol] the intermediate locations 1207b that require less lateral support in some embodiments.

Support members 217, 603, 703 of the disclosure can, for example, be provided as a single monolithic support member (e.g., a single monolithic support beam). In some alternative embodiments, as schematically shown in FIGS. 2, 3, 6 and 7, the support members 217, 603, 703 can optionally include a first support beam 218a, 604a, 704a and a second support beam 218b, 604b, 704b that supports the first support beam. As shown, the first support beam 218a, 604a, 704a and second support beam 218b, 604b, 704b can comprise a stack of support beams where the first support beam 218a, 604a, 704a is stacked on top of the second support beam 218b, 604b, 704b. Providing a stack of support beams can simplify and/or reduce the cost of fabrication. For instance, in some embodiments, the second support beam 218b, 604b, 704b can be longer than the first support beam 218a, 604a, 704a such that opposite end portions of the second support beam 218b, 604b, 704b can extend laterally outside of the width of the root 145 to be supported (e.g., simply supported) at opposite locations 158a, 158b as shown in FIGS. 1 and 4. As such, the second support beam 218b, 604b, 704b can be longer than the width “W” of the formed glass ribbon 103 and can extend through a hollow area 219 laterally extending through the forming vessel 140, 401, 701, 901 to fully support the forming vessel along the length of the forming vessel. Furthermore, the second support beam 218b, 604b, 704b may comprise a shape such as the illustrated rectangular shape although a hollow shape, a shape of an I-beam or other shape may be provided to reduce material costs while still providing a relatively high bending moment of inertial for the support beam. Furthermore, the first support beam 218a, 604a, 704a can be fabricated with a shape to support the containment device to help maintain the shape and dimensions of the containment device as discussed above.

In some embodiments, the first support beam 218a, 604a, 704a and the second support beam 218b, 604b, 704b may be fabricated from substantially the same or identical material although alternative materials may be provided in further embodiments. In some embodiments, like the support member 217 discussed above, the support members 603, 703 can be fabricated from a support material with a creep rate from 1×10⁻¹² l/s to 1×10⁻¹⁴ l/s under a pressure of from 1 MPa to 5 MPa at a temperature of 1400° C. In some embodiments, the support member po [symbol] support a weight of the containment device can be fabricated from ceramic material (e.g., silicon carbide) that, in some embodiments, can comprise a creep rate from 1×10⁻¹² l/s to 1×10⁻¹⁴ l/s under a pressure of from 1 MPa to 5 MPa at a temperature of 1400° C. Such a support material can provide sufficient support for the containment device and molten material carried by the containment device at high temperatures (e.g., 1400° C.) with minimal creep to provide a forming vessel 401, 701, 901 that minimizes use of platinum or other expensive refractory materials ideal for physically contacting the molten material without contaminating the molten material while providing a support member 603, 703 fabricated from a relatively less expensive material that can withstand large stresses under the weight of the forming vessel and molten material carried by the forming vessel. At the same time, the support member 603, 703 fabricated from the material discussed above can withstand creep under high stress and temperature to allow maintenance of the position and shape of the containment device and walls (e.g., platinum walls) associated with the containment device.

Any of the forming vessels 401, 701, 901 of the embodiments of the disclosure can comprise a forming wedge. For example, as shown in FIGS. 4 and 6, the forming vessel 401 includes a forming wedge 407 positioned downstream from the slot 501 of the conduit 403, 903 in the draw direction 154. As shown in FIG. 6, the forming wedge 407 can include a first sidewall 611a defining a first wedge surface 613a and a second sidewall 611b defining a second wedge surface 613b. As shown in FIG. 6, the first wedge surface 613a and the second wedge surface 613b can converge in the downstream draw direction 154 to form a root 615 of the forming wedge 407.

In some embodiments, the sidewalls 611a, 611b can comprise a platinum and/or a platinum alloy similar or identical to the composition of the conduits although different compositions may be employed in further embodiments. As such, in some embodiments, the first sidewall 611a and the second sidewall 611b can each comprise a platinum sidewall. In order to reduce material costs, the thickness of the sidewalls 611a, 611b (e.g., platinum sidewalls) can, for example, be within a range from about 3 mm to about 7 mm. A reduced thickness can result in overall reduced material costs. At the same time, the configuration of the sidewalls and/or the placement of the support member can provide the sidewalls wit [symbol] structural integrity to resist deformation in use despite the relatively low thickness. For instance, as shown in FIGS. 6 and 7, the support member 603, 703 can be positioned between an upstream portion 617a of the first sidewall 611a and an upstream portion 617b of the second sidewall 611b. As such, the spacing between the upstream portions 617a, 617b can be maintained by the support member 603, 703 positioned therebetween. Furthermore, a hollow area 219 can optionally be provided that can further reduce material costs and allow the support member to extend through the hollow area to support the conduit at locations 158a, 158b. Furthermore, the first sidewall 611a and the second sidewall 611b converge in the downstream draw direction 154 to form the root 615 wherein a strong triangular construction can be formed by the sidewalls and the base of the support members 603, 703. As such, a structurally rigid configuration can be achieved with relatively thin sidewalls within the range from about 3 mm to about 7 mm.

As shown in FIGS. 6 and 7, in some embodiments, an upstream end 619a of the upstream portion 617a of the first sidewall 611a (e.g., platinum sidewall) can be attached to the peripheral wall 405 of the conduit 403 (e.g., platinum conduit) at a first interface 621a. Likewise, an upstream end 619b of the upstream portion 617b of the second sidewall 611b (e.g., platinum sidewall) can be attached to the peripheral wall 405 of the conduit 403 (e.g., platinum conduit) at the second interface 621b. As shown, the first interface 621a and the second interface 621b can be each located downstream from the slot 501 of the conduit 403. In some embodiments, the upstream ends 619a, 619b of the sidewalls 611a, 611b can be welded to the peripheral wall 405 of the conduit 403 and machined to have a smooth corresponding interface 621a, 621b between the outer surface of the upper portion of the conduit and the outer surface of the sidewalls.

In some embodiments, the upstream portions of the first and second sidewall can be parallel with one another as shown in FIG. 7. Alternatively, as shown in FIG. 6, the upstream portion 617a of the first sidewall 611a and the upstream portion 617b of the second sidewall 611b initially flare away from one another in the downstream direction 154 from the corresponding interface 621a, 621b. Flaring the sidewalls away from one another can facilitate downward flow of molten material along the downstream direction 154 while also allowing increased space for the support member 603 in some embodiments. For instance, as [symbol] FIG. 6, the support surface 605 of the support member 603 can be defined by a base wall 608 and to opposed inwardly facing channel wall surfaces of opposite channel walls 606a, 606b extending upwardly from the base wall 608. The inwardly facing channel wall surfaces of the opposite channel walls 606a, 606b and the inwardly facing bottom surface of the base wall 608 can form a cradle defining the area 609 that can comprise the illustrated channel area to receive the second portion 404b of the peripheral wall 405.

In some embodiments, the material of the wall may be incompatible for physical contact with the material of the support member 603, 703. For example, in some embodiments, the wall can comprise platinum (e.g. platinum or platinum alloy) and the support member 603, 703 can comprise silicon carbide that may corrode or otherwise chemically react with the platinum of the wall contacts the support member. As such, in some embodiments, to avoid contact between incompatible materials, any portion of the wall (e.g., first sidewall 611a, second sidewall 611b) and any portion of the conduit 403, 903 may be prevented from physically contacting any portion of the support member 603, 703. As shown, for example, in FIGS. 6 and 7, the first sidewall 611a and the second sidewall 611b are each spaced from physically contacting any portion of the support member 603, 703. Furthermore, the conduit 403, 903 can be spaced from physically contacting any portion of the support member 603, 703. Various techniques can be used to space the wall from the support member. For example, pillars or ribs may be provided to provide spacing.

In further embodiments, as shown, a layer of intermediate material 623 may be provided between the sidewalls 611a, 611b and the support member 603, 703 to space the sidewalls 611a, 611b and the conduit 403, 903 from contacting the support member 603, 703. In some embodiments, the layer of intermediate material 623 may be continuously provided between all portions of the sidewalls 611a, 611b and adjacent spaced portions of the support member 603, 703. Providing a continuous layer of intermediate material 623 can facilitate even support across all portions of the sidewalls by the surface of the support member 603, 703 spaced from the sidewalls.

As shown, in some embodiments, the second por [symbol] 904b of the peripheral wall 405, 905 of the conduit 403, 903 can be positioned within the area 609 support member 603, 703 and supported by the support member 603, 703, wherein conduit 403, 903 (e.g., all portions of the conduit) can be spaced from physically contacting any portion of the support member 603, 703. For instance, as shown, the layer of intermediate material 623 may be provided as a continuous layer of intermediate material to space all portions of the conduit 403, 903 from physically contacting any portion of the support member 603, 703. As such, the layer of intermediate material 923 can provide continuous support of the portions of the conduit 403, 903 to increase strength and resistance to deformation and creep of the conduit 403, 903.

Various materials can be used as the intermediate material 923 depending on the materials of the wall and the support member. For instance, the material can comprise alumina or other material that is compatible for contacting platinum and silicon carbide under high temperature and pressure conditions associated with containing and guiding molten material with the forming vessels 401, 701, 901, 1101, 1201. Thus, in some embodiments, platinum or platinum alloy sidewalls and platinum conduit can be spaced from physically contacting any portion of a support member 603, 703 comprising silicon carbide by way of a layer of intermediate material comprising alumina.

Methods of fabricating the glass ribbon 103 from the quantity of molten material 121 with any of the forming vessels 401, 701, 901, 1101, 1201 discussed above can include flowing the molten material 121 within the region 801 in the flow direction 803 of the conduit 403, 903. Referring to FIGS. 6 and 7, the method can further include flowing the molten material 121 through the slot 501 from the region 801 of the conduit 403, 903 as a first stream 625a of molten material and a second stream 625b of molten material. The method can still further include flowing the first stream 625a of molten material on the first wedge surface 613a along the downstream direction 154 and the second stream of molten material 625b on the second wedge surface 613b along the downstream direction 154. The method can then include fusion drawing the first stream 625a of molten material and the second stream 625b of molten material from the root 615 of the forming wedge 407 as the glass ribbon 103.

It will be appreciated that the various disclosed em [symbol] may involve particular features, elements or steps that are described in connection with that particular embodiment. It will also be appreciated that a particular feature, element or step, although described in relation to one particular embodiment, may be interchanged or combined with alternate embodiments in various non-illustrated combinations or permutations.

It is also to be understood that, as used herein the terms “the,” “a,” or “an,” mean “at least one,” and should not be limited to “only one” unless explicitly indicated to the contrary. Likewise, a “plurality” is intended to denote “more than one.”

Ranges can be expressed herein as from “about” one particular value, and/or to “about” another particular value. When such a range is expressed, embodiments include from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to an apparatus that comprise [symbol] include embodiments where an apparatus consists of A+B+C and embodiments where an apparatus consists essentially of A+B+C.

It will be apparent to those skilled in the art that various modifications and variations can be made to the present disclosure without departing from the spirit and scope of the appended claims. Thus, it is intended that the present disclosure cover the modifications and variations of the embodiments herein provided they come within the scope of the appended claims and their equivalents.

1-61. (canceled)

62. An apparatus comprising:
a conduit comprising a peripheral wall defining a region extending in a flow direction of the conduit, a first portion of the peripheral wall comprising a slot extending through an outer peripheral surface of the peripheral wall, wherein the slot is in communication with the region;
a support member comprising a support surface defining an area receiving a second portion of the peripheral wall, wherein the support member comprises a support material comprising a creep rate from 1×10⁻¹² l/s to 1×10⁻¹⁴ l/s under a pressure of from 1 MPa to 5 MPa at a temperature of 1400° C.; and
a forming wedge positioned downstream from the slot of the conduit, the forming wedge comprising a first wedge surface and a second wedge surface that converge in a downstream direction to form a root of the forming wedge.

63. An apparatus comprising:
a conduit comprising a peripheral wall defining a region extending in a flow direction of the conduit, a first portion of the peripheral wall comprising a slot extending through an outer peripheral surface of the peripheral wall, wherein the slot is in communication with the region;
a silicon carbide support member comprising a support surface defining an area receiving a second portion of the peripheral wall; and
a forming wedge positioned downstream from the slot of the conduit, the forming wedge comprising a first wedge surface and a second wedge surface that converge in a downstream direction to form a root of the forming wedge.

64. The apparatus of claim 62, wherein the support material comprises a ceramic material.

65. The apparatus of claim 64, wherein the ceramic material comprises silicon carbide.

66. The apparatus of any one of claims 62-63, wherein the support surface surrounds from about 25% to about 60% of the outer peripheral surface of the peripheral wall.

67. The apparatus of any one of claims 62-63, wherein a depth of the area receiving the second portion of the peripheral wall varies along a length of the slot.

68. The apparatus of claim 67, wherein the depth of the area receiving the second portion of the peripheral wall is greatest at a location of less than about 33% of the length of the slot measured in the flow direction of the conduit.

69. The apparatus of claim 67, wherein the conduit comprises a first conduit connected in series with a second conduit at a joint, wherein the depth of the area receiving the second portion of the peripheral wall is greater at a lateral location of the joint than at an intermediate lateral location of the first conduit and an intermediate lateral location of the second conduit.

70. The apparatus of any one of claims 62-63, wherein the first portion of the peripheral wall is opposite the second portion of the peripheral wall.

71. The apparatus of any one of claims 62-63, wherein the width of the slot increases in the flow direction of the conduit.

72. The apparatus of any one of claims 62-63, wherein a cross-sectional area of the region taken perpendicular to the flow direction of the conduit decreases in the flow direction of the conduit.

73. The apparatus of any one of claims 62-63, wherein the outer peripheral surface of the peripheral wall comprises a circular shape along a cross-section taken perpendicular to the flow direction of the conduit.

74. The apparatus of any one of claims 62-63, wherein a thickness of the peripheral wall of the conduit is from about 3 mm to about 7 mm.

75. The apparatus of any one of claims 62-63, wherein the peripheral wall of the conduit comprises platinum.

76. The apparatus of any one of claims 62-63, further comprising a first sidewall defining the first wedge surface and a second sidewall defining the second wedge surface.

77. The apparatus of claim 76, wherein the first sidewall comprises platinum and the second sidewall comprises platinum.

78. The apparatus of claim 76, wherein the support member is positioned between the first sidewall and the second sidewall.

79. The apparatus of claim 76, wherein the first sidewall and the second sidewall does not physically contact any portion of the support member.

80. The apparatus of claim 76, wherein an upstream end of an upstream portion of the first sidewall is attached to the peripheral wall of the conduit at a first interface, and an upstream end of an upstream portion of the second sidewall is attached to the peripheral wall of the conduit at a second interface.

81. The apparatus of claim 80, wherein the first interface and the second interface are each located downstream from the slot of the conduit.

82. The apparatus of claim 80, wherein the upstream portion of the first sidewall and the upstream portion of the second sidewall flare away from one another in the downstream direction.

83. An apparatus comprising:
a support member comprising a support trough, a first support weir, and a second support weir, and the support trough laterally positioned between the first support weir and the second support weir, wherein the support member comprises a support material comprising a creep rate from 1×10⁻¹² l/s to 1×10⁻¹⁴ l/s under a pressure of from 1 MPa to 5 MPa at a temperature of 1400° C.;
an upper wall at least partially defining a molten material trough positioned within the support trough and supported by the support trough, wherein the upper wall is does not physically contact any portion of the support member;
a first sidewall comprising an upper portion attached to a first side of the upper wall, the first sidewall is does not physically contact any portion of the support member;
a second sidewall comprising an upper portion attached to a second side of the upper wall, the second sidewall does not physically contact any portion of the support member; and
a forming wedge comprising a first wedge surface defined by a lower portion of the first sidewall and a second wedge surface defined by a lower portion of the second sidewall, wherein the first wedge surface and the second wedge surface converge in a downstream direction to form a root of the forming wedge.

84. An apparatus comprising:
a silicon carbide support member comprising a support trough, a first support weir, and a second support weir, and the support trough laterally positioned between the first support weir and the second support weir;
an upper wall at least partially defining a molten material trough positioned within the support trough and supported by the support trough, wherein the upper wall does not physically contact any portion of the silicon carbide support member;
a first sidewall comprising an upper portion attached to a first side of the upper wall, the first sidewall does not physically contact any portion of the support member;
a second sidewall comprising an upper portion attached to a second side of the upper wall, the second sidewall does not physically contact any portion of the support member; and
a forming wedge comprising a first wedge surface defined by a lower portion of the first sidewall and a second wedge surface defined by a lower portion of the second sidewall, wherein the first wedge surface and the second wedge surface converge in a downstream direction to form a root of the forming wedge.

85. The apparatus of claim 83, wherein the support material comprises a ceramic material.

86. The apparatus of claim 85, wherein the ceramic material comprises silicon carbide.

87. The apparatus of any one of claims 83-84, wherein an intermediate material prevents the upper wall, the first sidewall and the second sidewall from physically contacting any portion of the support member.

88. The apparatus of claim 87, wherein the intermediate material comprises alumina.

89. The apparatus of any one of claims 83-84, wherein the upper wall, first sidewall and second sidewall each comprise a thickness within a range from about 3 mm to about 7 mm.

90. The apparatus of claim 83-84, wherein the upper wall, first sidewall and second sidewall each comprise platinum.

91. The apparatus of any one of claims 83-84, wherein the support member is positioned between the first sidewall and the second sidewall.

92. An apparatus comprising:
a containment device including a surface defining a region extending in a flow direction of the containment device;
a support member positioned to support a weight of the containment device, wherein the support member comprises a support material comprising a creep rate from 1×10⁻¹² l/s to 1×10⁻¹⁴ l/s under a pressure of from 1 MPa to 5 MPa at a temperature of 1400° C.; and
a platinum wall that does not physically contact any portion of the support member.

93. An apparatus comprising:
a containment device including a surface defining a region extending in a flow direction of the containment device;
a silicon carbide support member positioned to support a weight of the containment device; and
a platinum wall that does not physically contact any portion of the support member.

94. The apparatus of claim 92, wherein the support material comprises a ceramic material.

95. The apparatus of claim 94, wherein the ceramic material comprises silicon carbide.

96. The apparatus of any one of claims 92-93, wherein the containment device comprises a platinum conduit comprising a peripheral wall defining the region, a first portion of the peripheral wall comprising a slot extending through an outer peripheral surface of the peripheral wall, wherein the slot is in communication with the region.

97. The apparatus of claim 96, wherein the support member comprises a support surface defining an area receiving a second portion of the peripheral wall.

98. The apparatus of claim 97, wherein the support surface surrounds from about 25% to about 60% of the outer peripheral surface of the peripheral wall.

99. The apparatus of any one of claims 92-93, wherein a depth of the area receiving the second portion of the peripheral wall varies along a length of the slot.

100. The apparatus of claim 99, wherein the depth of the area receiving the second portion of the peripheral wall is greatest at a location of less than about 33% of the length of the slot measured in the flow direction of the containment device.

101. The apparatus of claim 99, wherein the platinum conduit comprises a first platinum conduit connected in series with a second platinum conduit at a joint, wherein the depth of the area receiving the second portion of the peripheral wall is greater at a lateral location of the joint than at an intermediate lateral location of the first platinum conduit and an intermediate lateral location of the second platinum conduit.
